(19) United States
(12) Patent Application Publication
(10) Pub. No.: US 2018/0063893 A1
(43) Pub. Date: Mar. 1, 2018

(54) HOB DEVICE

(71) Applicant: BSH Hausgeräte GmbH, Munich (DE)

(72) Inventors: Carlos Franco Gutierrez, Zaragoza (ES); Teresa Del Carmen Marzo Alvarez, Zaragoza (ES); Silvia Monfort Soler, Zaragoza (ES); David Paesa Garcia, Zaragoza (ES); Beatriz Villanueva Valero, Zaragoza (ES)

(21) Appl. No.: 15/560,497

(22) PCT Filed: Mar. 10, 2016
(86) PCT No.: PCT/IB2016/051363

§ 371 Date: Sep. 22, 2017

(30) Foreign Application Priority Data
Apr. 9, 2015 (ES) P201530470

(51) Int. Cl. H05B 6/06; F24C 7/08; A47J 27/00

(52) U.S. Cl. CPC H05B 6/062; H05B 2213/07; A47J 27/002; F24C 7/083

(57) ABSTRACT

A generic hob device having improved characteristics with regard to high operating convenience includes an output unit and a control unit. The hob device outputs by the output unit a catalogue of recipes for selection, and depending on an operating input, the hob device leads an operator through a selected recipe by the output unit.

The invention relates to a cooktop apparatus as claimed in claim 1 and a method for operating a cooktop apparatus as claimed in claim 13.

A cooktop apparatus comprising an output unit and a control unit is already known from DE 10 2011 050 123 A1. The control unit guides an operator through a single predefined recipe, in which the control unit outputs an operating prompt for turning a food being cooked and for detecting a temperature by means of a sensor configured as a temperature probe to the operator by way of the output unit after a predetermined time period. The sensor configured as a temperature probe must be inserted into the food by an operator here.

The object of the invention is in particular to provide a generic cooktop apparatus with improved characteristics in respect of a high level of operating convenience. According to the invention the object is achieved by the features of claims 1 and 13, while advantageous embodiments and developments of the invention will emerge from the subclaims.

A cooktop apparatus, in particular an induction cooktop apparatus, is proposed, with an output unit and with a control unit, which is provided to output a catalog of recipes for selection by way of the output unit and to guide an operator through a selected recipe by way of the output unit as a function of at least one operating input. A “cooktop apparatus” refers in particular to at least a part, in particular a sub-assembly, of a cooktop, in particular an induction cooktop. The cooktop can in particular also comprise the entire cooktop, in particular the entire induction cooktop. An “output unit” refers in particular to a unit, which is provided to provide an operator with at least one characteristic variable in particular visually and/or acoustically and/or haptically, for example information and/or time details and/or an operating prompt and/or an action prompt and/or a selection. The output unit could be provided in particular to output at least one acoustic signal and/or in particular at least one acoustic sequence, for example a ringtone and/or a warning signal and/or a prompt in the form of an in particular prepared sentence. Alternatively or additionally the output unit could be provided to provide a visual output, for example to display at least one image and/or at least one text and/or at least one digit and/or at least one animation. For example the output unit could have at least one speaker. Alternatively or additionally the output unit could have a display unit, in particular with at least one illuminant, advantageously an LED, and/or an in particular back-lit display, in particular a matrix display and/or an LCD display, an OLED display and/or electronic paper. The output unit advantageously has at least one liquid crystal display. A “control unit” refers in particular to an electronic unit, which is preferably at least partially integrated in a control and/or regulation unit of a cooktop and which is provided in particular to control and/or regulate at least one heating element and in particular at least one electronic power unit supplying the heating element. The control unit preferably comprises a computation unit and in particular in addition to the computation unit a storage unit with a control and/or regulation program stored therein, which is provided to be executed by the computation unit. The control unit is provided in particular to communicate and/or interact with the operator, in particular by way of the output unit and/or by way of an operating unit. For example the control unit could be provided at least to output at least one temperature information item, for example in particular an in particular current temperature and/or a setpoint temperature, by way of the output unit in particular to the operator. A “catalog” of recipes refers in particular to a selection of at least two, in particular at least three, advantageously at least four, particularly advantageously at least five, preferably at least seven and particularly preferably at least ten, recipes. A “recipe” refers in particular to a time sequence of heat settings and/or other operational settings and/or action prompts and/or recipe steps for preparing at least one food to be cooked. The heat settings here comprise in particular at least one heating period and/or at least one heat output and/or at least one heating temperature and/or at least one manner of heating, for example roasting and/or boiling and/or deep-frying and/or sautéing and/or poaching and/or baking and/or grilling. The operational settings comprise in particular at least one time period, which defines an overall duration of the recipe and/or at least one time sequence of recipe steps and/or at least one manner of outputting by way of the output unit, for example visually and/or acoustically. At least one of the recipes has in particular at least one temperature-critical recipe step, in which in particular a deviation of a value of a current temperature from a setpoint temperature of at least 1%, in particular at least 2%, advantageously at least 3%, particularly advantageously at least 5%, preferably at least 7% and more preferably at least 10%, results in a failure to achieve a result to be achieved in the first recipe step. At least one of the recipes, in particular at least two, advantageously at least three, particularly advantageously at least four, preferably at least five, more preferably at least seven and particularly preferably at least ten recipes in particular has/have at least two recipe steps. A “recipe step” refers in particular to a sub-segment of a recipe, which comprises an in particular defined time period and an in particular defined method step, for example a heating step and/or a step including an interaction by way of the output unit and/or a step including an interaction by way of an operating unit, the time period being in particular fixed and/or variable, for example in particular as a function of a time period required for an operating input by means of the operating unit. The cooktop apparatus comprises in particular at least one operating unit, which is provided for inputting and/or selecting operating parameters, for example a heat output and/or a heat output density and/or a time period and/or a heating zone and/or a recipe. The expression that the control unit is provided to output a catalog of recipes “for selection” by way of the output unit means in particular that the control unit outputs the catalog of recipes to an operator by way of the output unit in particular together with an operating prompt and in particular waits for an operating input by means of an operating unit before the control unit executes at least one further action, for example a selected recipe. An “operating input” refers in particular to a visual and/or acoustic input by means of the operating unit in particular by an operator. The expression that the control unit is provided to “guide” an operator through a selected recipe by way of the output unit means in particular that the control unit is provided to prompt the operator to act and/or to output information by means of at least one output by way of the output unit and/or that the control unit is provided automatically to undertake and/or initiate recipe steps required to perform the selected recipe. “Automatically” means in particular in a self-activated manner and/or avoiding interaction by means of the operating unit and/or avoiding operator action. The cooktop apparatus comprises in particular at least one sensor, for example a contact sensor and/or an optical sensor and/or an NTC resistor and/or a PTC resistor, the sensor being provided in particular to detect at least one temperature of at least one cookware item positioned thereon. The sensor is in particular arranged at least essentially in a fixed position. In particular the cooktop apparatus comprises at least one cooktop plate, which is provided in particular for the positioning of cookware thereon. The sensor is arranged in particular below the cooktop plate in the installed position. Alternatively or additionally the sensor could be arranged above the cooktop plate and could be connected in particular to the cooktop plate and/or fastened to the cooktop plate in the installed position. “Provided” means in particular specifically programmed, designed and/or equipped. That an object is provided for a specific function means in particular that the object satisfies and/or performs said specific function in at least one state of use and/or operation.

The inventive configuration in particular allows a high level of operating convenience to be achieved. In particular it allows simple preparation of food to be cooked and/or easy performance of at least one in particular complicated recipe. In particular it allows excellent results to be achieved in respect of quality and/or taste. In particular automatic cooking processes and the output unit can be combined, allowing in particular a competitive advantage to be achieved and/or a high level of operating convenience to be provided.

It is further proposed that a first setpoint temperature of a first recipe step of at least one of the recipes differs at least essentially from a second setpoint temperature of a second recipe step of the at least one recipe. A “setpoint temperature” refers in particular to a predefined temperature to be reached, which is assigned in particular to at least one cookware item and/or food to be cooked and which has at least one value, to which the control unit controls and/or regulates a value of a current temperature of the cookware item. The setpoint temperature could be stored for example in the storage unit of the control unit and/or could be predetermined by at least one operating input by means of the operating unit. The expression that a first setpoint temperature of a first recipe step “differs at least essentially” from a second setpoint temperature of a second recipe step means in particular that the first setpoint temperature has a value which differs by at least 5%, in particular at least 10%, advantageously at least 15%, particularly advantageously at least 20%, preferably at least 25% and more preferably at least 30% of a value of a greater of the setpoint temperatures from a value of the second setpoint temperature. This allows at least one item of food to be cooked optimally in particular. In particular a plurality of recipes can be provided and/or a high level of flexibility can be achieved.

The control unit could be provided for example to output an operating prompt for an operating input of a setpoint temperature and/or a setpoint heat output by way of the output unit as a function of a selection of at least one recipe and/or as a function of completion of at least one recipe step. The control unit is however advantageously provided to adjust a temperature automatically based on the selected recipe. The control unit is provided in particular to set a temperature of a following recipe step automatically on completion of a recipe step. The expression that the control unit is provided to “adjust” a temperature automatically based on the selected recipe means in particular that the control unit is provided to replace a first setpoint temperature of a first recipe step with a second setpoint temperature of a second recipe step as a function of the selected recipe in particular during a transition between at least two recipe steps and/or that the control unit is provided to control and/or regulate the current temperature of the cookware to a setpoint temperature of the cookware assigned to the cookware according to the selected recipe as a function of a current temperature of at least one cookware item detected in particular by the sensor. This in particular reduces the effort required by the operator and/or requires little activity on the part of the operator.

It is also proposed that the control unit has at least one timer and is provided to start at least one second recipe step after a predetermined time period has elapsed after at least one first recipe step. A “timer” refers in particular to a unit which is provided to provide at least one item of time information, which comprises in particular an absolute time, in particular of a radio clock, and/or an absolute and/or relative time period. A “predetermined” time period refers in particular to a time period stored in the storage unit of the control unit and/or a time period input by an operating input by means of the operating unit. This allows in particular a high level of precision and/or exact compliance with the recipe.

The control unit could be provided for example to use the timer solely for internal calculation, in order in particular to allow and/or ensure a targeted transition between at least two recipe steps. The control unit is advantageously provided in particular at least to output at least one item of time information relating to at least one recipe step by way of the output unit. The control unit could be provided in particular at least to output the time information acoustically, for example by means of a ring tone, and/or visually, for example by means of a display of time that has elapsed and/or remains, by way of the output unit. The control unit is provided in particular to output at least one item of temperature information and/or at least one item of progress information by way of the output unit. The temperature information could comprise for example a setpoint temperature to be reached according to the recipe step and/or a current temperature in particular of the cookware. The progress information could comprise for example a number of recipe steps remaining and/or still to be performed according to the selected recipe and/or a total number of recipe steps. “Time information” refers in particular to information about an absolute time, for example a precise time in particular of a radio clock, and/or information about a time period, for example a time period that has already elapsed and/or remains, in particular of a recipe step and/or of a recipe comprising the recipe step. This can in particular provide easy guidance through the selected recipe.

It is further proposed that the control unit is provided to output at least one notification relating to a transition from at least one first recipe step to at least one second recipe step by way of the output unit. The notification could comprise for example at least one acoustic signal, it being possible for the control unit to be provided for example to output at least one acoustic signal at predetermined time intervals from a predetermined time period before the end of the recipe step and/or recipe in order to notify the operator of the upcoming transition. Alternatively or additionally the notification could comprise for example at least one visual signal, it being possible for the control unit to be provided to output the notification during the entire recipe step and/or recipe and/or to output the notification solely from a predetermined time period before the end of the recipe step and/or recipe. This in particular prevents the operator missing a transition from the first recipe step to the second recipe step and/or at least one action to be undertaken in particular by said operator during the transition.

It is further proposed that the control unit is provided to output at least one operating prompt by way of the output unit. An “operating prompt” refers in particular to a prompt for an operating input by means of the operating unit and/or for the performance of an action, in particular in relation to at least one item of food to be used according to the selected recipe. This saves the operator in particular having to determine for him/herself actions to be undertaken and/or operating inputs by means of the operating unit.

The operating prompt could comprise for example a prompt to adjust a setpoint temperature and/or setpoint heat output in particular during a transition between at least two recipe steps in the event that the control unit does not automatically undertake such an adjustment. Alternatively or additionally the operating prompt could be a prompt to undertake an action relating to at least one food item to be used according to the selected recipe, for example stirring and/or adding ingredients, such as seasonings for example and/or sauces and/or liquid and/or fat. The operating prompt advantageously comprises a prompt to lie and/or stand food in position, it being possible as a result for the food to be put in position in particular at the correct time point and/or when an optimum temperature has been reached.

It is also proposed that the operating prompt comprises a prompt to turn food, thereby in particular preventing food burning.

It is also proposed that the control unit is provided automatically to deactivate at least one activated heating element on completion of the selected recipe. The cooktop apparatus advantageously comprises at least one heating element, in particular at least two, advantageously at least three, particularly advantageously at least five, preferably at least seven and more preferably ten heating elements and particularly preferably a plurality of heating elements. A “heating element” in this context refers in particular to an element which is provided to convert energy, preferably electrical energy, to heat and in particular to supply it to at least one cookware item positioned thereon. The heating element is advantageously configured in particular as an induction heating element and it is preferably provided to generate an electromagnetic alternating field in particular with a frequency of 20 kHz to 100 kHz, which is provided in particular to be converted to heat in an in particular metal, preferably ferromagnetic, cookware base positioned thereon due to eddy current induction and/or magnetic reversal effects. The expression that the control unit is provided automatically to “deactivate” at least one activated heating element means in particular that the control unit activates an electronic power unit, which interrupts and/or terminates an energy supply to the activated heating element as a function of activation by the control unit. This allows in particular an energy-saving and/or environmentally friendly embodiment to be achieved, as activation of heating elements can be limited in particular to a required time period.

It is further proposed that the control unit has a storage unit, in particular the storage unit, and is provided to store at least one further recipe in the storage unit and/or in particular to add the further recipe to the catalog of recipes as a function of an operating input. The control unit is provided in particular to amend at least one recipe from the catalog of recipes and store it in amended form in the storage unit as a function of at least one operating input by means of the operating unit. Alternatively or additionally the control unit could be provided in particular to output at least one operating prompt by way of the output unit and to prompt an operator to perform at least one operating input by means of the operating unit, for example to confirm and/or change at least one value and/or at least one setting of the recipe, before the start of the selected recipe and/or before the start of at least one recipe step of the selected recipe. This allows in particular a high level of flexibility and/or a high level of individuality to be achieved in respect of recipes.

A method for operating a cooktop apparatus with an output unit is also proposed, a catalog of recipes for selection being output by way of the output unit and an operator being guided through a selected recipe as a function of an operating input by way of the output unit. This allows a high level of operating convenience in particular to be achieved.

The cooktop apparatus here should not be restricted to the application and embodiment described above. In particular the cooktop apparatus can feature a number of individual elements, components and units that is different from the number cited herein to satisfy a mode of operation described herein.

Further advantages will emerge from the description of the drawing which follows.

The drawing shows exemplary embodiments of the invention. The drawing, description and claims contain numerous features in combination. The person skilled in the art will expediently also consider the features individually and combine them in useful further combinations.

In the drawing:

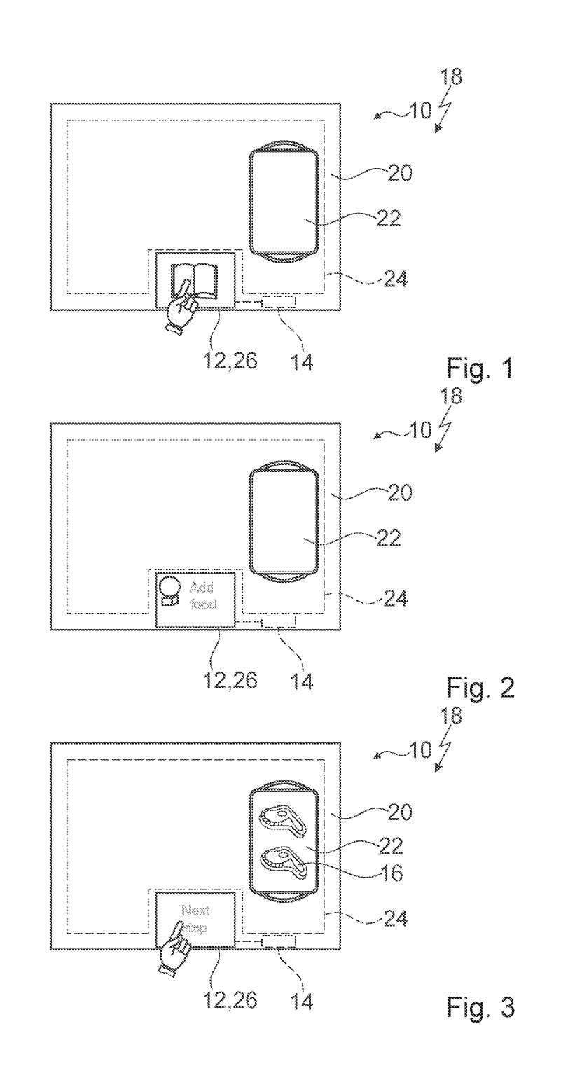

FIG. 1 shows a schematic top view of a cooktop with a cooktop apparatus and a cookware item in a first method step,

FIG. 2 shows a schematic top view of the cooktop with the cooktop apparatus and the cookware item in a second method step,

FIG. 3 shows a schematic top view of the cooktop with the cooktop apparatus and the cookware item in a third method step,

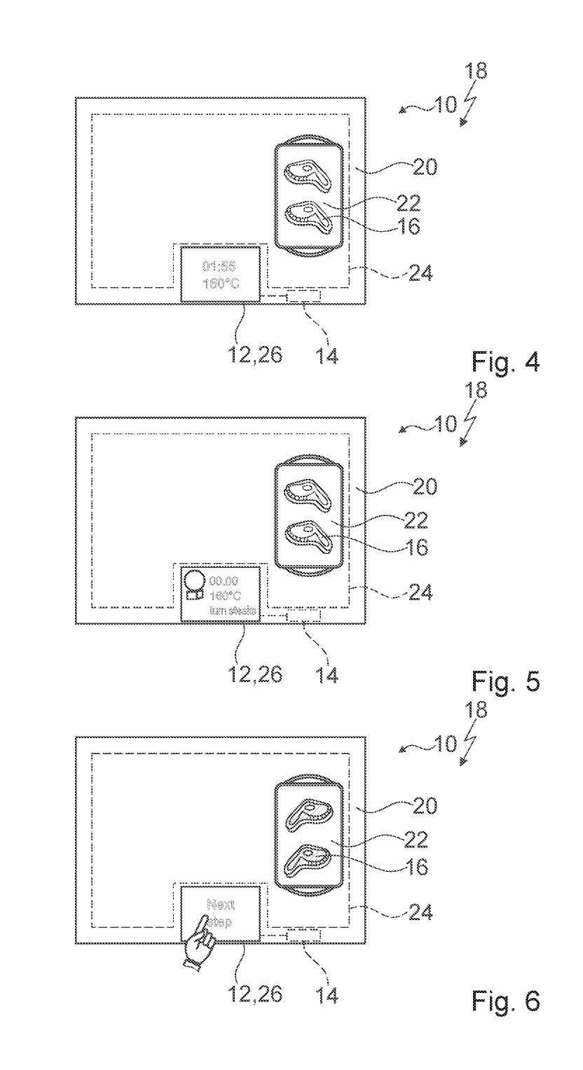

FIG. 4 shows a schematic top view of the cooktop with the cooktop apparatus and the cookware item in a fourth method step,

FIG. 5 shows a schematic top view of the cooktop with the cooktop apparatus and the cookware item in a fifth method step,

FIG. 6 shows a schematic top view of the cooktop with the cooktop apparatus and the cookware item in a sixth method step,

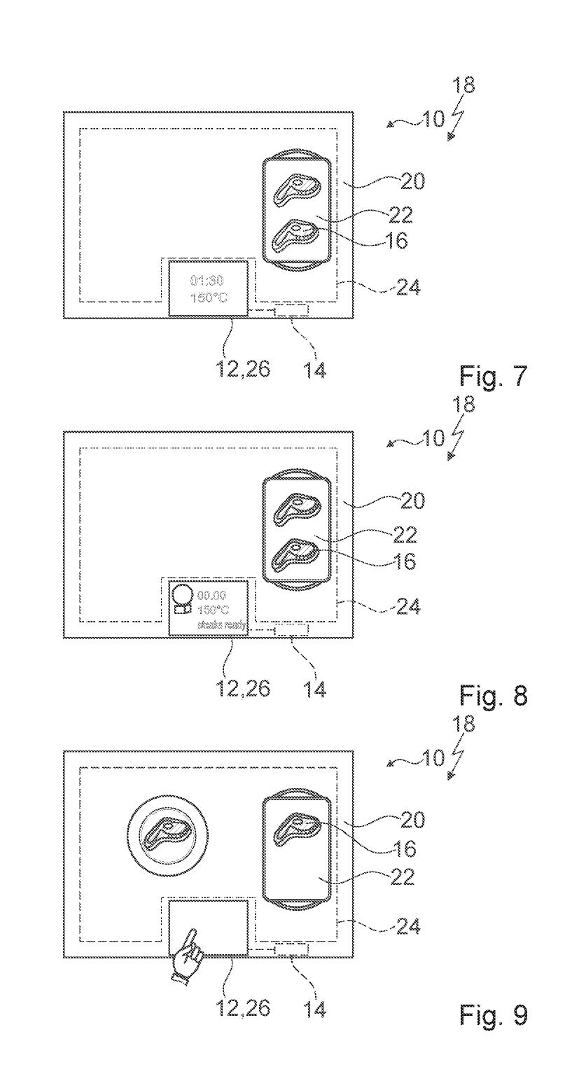

FIG. 7 shows a schematic top view of the cooktop with the cooktop apparatus and the cookware item in a seventh method step,

FIG. 8 shows a schematic top view of the cooktop with the cooktop apparatus and the cookware item in an eighth method step,

FIG. 9 shows a schematic top view of the cooktop with the cooktop apparatus and the cookware item in a ninth method step and

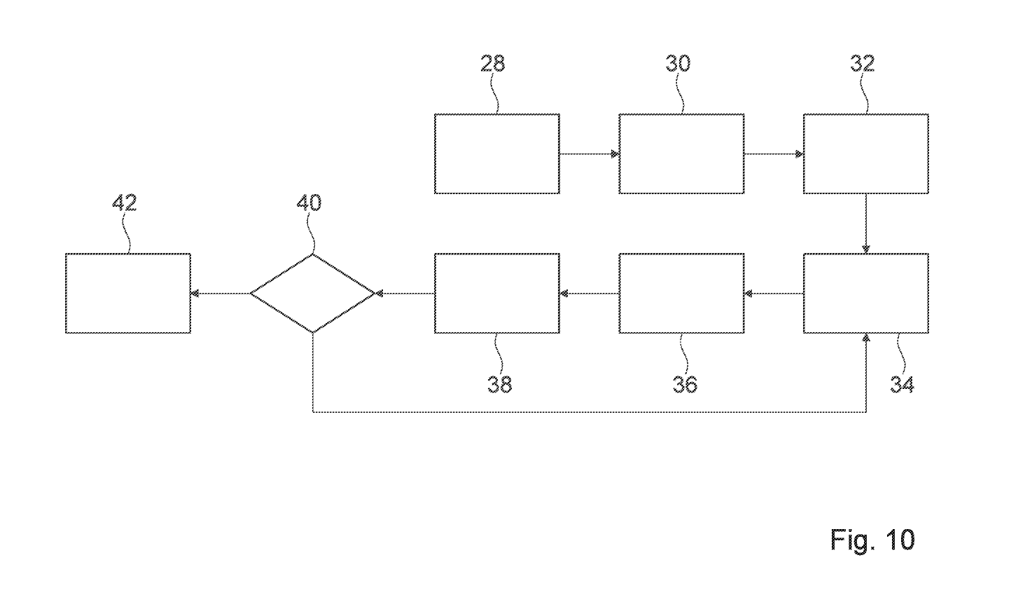

FIG. 10 shows a schematic diagram of a sequence of a method for operating the cooktop apparatus.

FIG. 1 shows a cooktop 18, which is configured as an induction cooktop, with a cooktop apparatus 10, which is configured as an induction cooktop apparatus. The cooktop apparatus 10 comprises a cooktop plate 20. In a mounted state the cooktop plate 20 forms part of an outer housing, in particular an outer housing of the cooktop 18. The cooktop plate 20 is provided to have cookware 22 positioned thereon (see FIGS. 2 to 9).

The cooktop apparatus 10 comprises at least one heating element (not shown). In the present exemplary embodiment the cooktop apparatus 10 comprises a plurality of heating elements. The heating elements are arranged in the form of a cooktop matrix. Alternatively the cooktop apparatus could comprise a larger or smaller number of heating elements. For example the cooktop apparatus could have in number two to six heating elements, which could be arranged for example at a distance from one another and in particular in the form of a conventional cooktop. In the present exemplary embodiment the heating elements define a variable cooking surface region 24. The variable cooking surface region 24 is provided to heat cookware 22 positioned on the cooktop plate 20 above the heating elements.

The cooktop apparatus 10 comprises an operating unit 26 for inputting and/or selecting operating parameters, for example a heat output and/or a heat output density and/or a temperature and/or a heating zone and/or a recipe. The operating unit could comprise for example at least one mechanical operating element, such as in particular a knob and/or a joystick and/or a disk and/or a button and/or a lever. In the present exemplary embodiment the operating unit 26 has at least one touch-sensitive operating element (not shown). The operating unit 26 here has a number of touch-sensitive operating elements. Only one of the operating elements is described in the following.

The cooktop apparatus 10 comprises an output unit 12. The output unit 12 is provided to output a value of an operating parameter to an operator. The output unit 12 is provided to output visually. Alternatively or additionally the output unit could be provided in particular to output acoustically. The operating unit 26 and the output unit 12 are configured partially as a single piece. The output unit 12 has a display. The display is configured as a liquid crystal display, which is known in particular by the abbreviation TFT.

The cooktop apparatus 10 comprises a control unit 14. The control unit 14 is provided to perform actions and/or change settings as a function of operating parameters input by means of the operating unit 26. In a heating mode state the control unit 14 regulates an energy supply to the heating elements. In the heating mode state the control unit 14 transmits a signal to provide an energy supply to the heating elements to an electronic power unit (not shown). The cooktop apparatus 10 comprises the electronic power unit, which provides an energy supply to the heating elements as a function of a signal transmitted by the control unit 14.

In a method for operating the cooktop apparatus 10 a cookware item 22 is put in position in a first method step. When a cookware item 22 is detected in position, the control unit outputs a catalog of recipes for selection by way of the output unit 12 in a selection step 28 (see FIGS. 1 and 10). In the selection step 28 an operator selects a recipe from the catalog of recipes by an operating input by means of the operating unit 26. The control unit 14 guides the operator through the selected recipe by way of the output unit 12 as a function of the operating input. The control unit 14 is provided to guide the operator through any type of selected recipe as a function of the operating input, for example through at least one temperature-critical and/or at least one non-temperature-critical recipe.

The control unit 14 outputs an operating prompt to select a heating zone by way of the output unit 12. In the selection step 28 the operator selects a heating zone for the positioned cookware 22 by an operating input by means of the operating unit 26.

In one recipe step of the selected recipe the control unit 14 outputs an operating prompt by way of the output unit 12 (see FIG. 2). The control unit 14 prompts the operator by means of the operating prompt to add fat, for example oil and/or margarine and/or cooking fat. Once an action required according to the operating prompt has been performed, the operator confirms the performed action by an operating input by means of the operating unit 26. The control unit 14 heats the cookware 22 to a setpoint temperature according to the selected recipe in a preheating step 30 (see FIGS. 2 and 10). In the preheating step 30 the control unit 14 heats the cookware 22 together with the fat in the cookware 22 to the setpoint temperature according to the selected recipe. Alternatively the control unit could be provided to heat an empty cookware item, to which in particular neither food nor any ingredient nor fat has been added, to a setpoint temperature, as could be the case for example for fat-free cooking.

The control unit 14 has a timer (not shown). The control unit 14 starts a second recipe step after a predetermined time period has elapsed after a first recipe step. Should a longer time period than the predetermined time period be required to achieve a result to be achieved in the first recipe step, the control unit 14 starts the second recipe step after the result to be achieved has been achieved. The result to be achieved could be for example reaching the setpoint temperature and/or melting fat and/or a specific cooking state of a food to be cooked.

In a food step 32 the control unit 14 outputs an operating prompt by way of the output unit 12 (see FIG. 10). The control unit 14 prompts the operator to lie and/or stand food in position. The operating prompt comprises the lying and/or standing of food. The control unit 14 prompts the operator to confirm the performance of an action required by the operating prompt (see FIGS. 3 and 10). The control unit 14 starts a cooking step 34 as a function of confirmation of the required action.

In the cooking step 34 the control unit 14 activates heating elements covered by the cookware 22 (see FIGS. 4 and 10). The control unit 14 regulates a current temperature of the cookware 22 to a setpoint temperature assigned to the cookware 22 according to a current recipe step according to the selected recipe. The setpoint temperature in the cooking step 34 differs essentially from the setpoint temperature in the preheating step 30. A first setpoint temperature of a first recipe step of the recipes differs essentially from a second setpoint temperature of a second recipe step of the recipe.

During a transition between two recipe steps of the selected recipe, which comprise in particular differing setpoint temperatures, the control unit 14 automatically adjusts a temperature based on the selected recipe. The control unit 14 outputs time information relating to the recipe step to the operator by way of the output unit 12, the control unit 14 performing said recipe step (see FIG. 4). In the present exemplary embodiment the control unit 14 outputs the time information in the form of a time period still remaining until the end of the recipe step by way of the output unit 12. The control unit 14 outputs temperature information relating to the recipe step to the operator by way of the output unit 12 (see FIG. 4).

After the end of the remaining time period the control unit 14 starts an interaction step 36 (see FIG. 10). The control unit 14 outputs a notification relating to a transition from a first recipe step to a second recipe step by way of the output unit 12 (see FIG. 5). In the interaction step 36 the control unit 14 outputs an operating prompt by way of the output unit 12. The control unit 14 prompts the operator to turn food 16. The operating prompt comprises the turning of food 16.

In a confirmation step 38 the control unit 14 prompts the operator to confirm the performance of an action required by the operating prompt (see FIGS. 6 and 10). The control unit 14 prompts the operator to confirm completion of the recipe step by way of the output unit 12. The operator confirms the completion of the recipe step by an operating input by means of the operating unit 26, if the desired result corresponds to an achieved result. Otherwise the operator changes at least one operating parameter of at least one recipe step of the selected recipe, in particular of the recipe step, for example a time period and/or a setpoint temperature, by an operating input by means of the operating unit 26. The control unit 14 continues to perform the recipe step as set out as a function of the operating input by means of the operating unit 26.

The control unit 14 starts a check step 40 (see FIG. 10) as a function of confirmation of completion of the recipe step. In the check step 40 the control unit 14 checks whether the selected recipe has been completed. If the control unit 14 determines in the check step 40 that at least one further recipe step of the selected recipe has yet to be performed, the control unit 14 repeats a cycle in the form of the cooking step 34, the interaction step 36 and the confirmation step 38 (see FIGS. 7, 8 and 10). Should an action by an operator be required before the start of a cycle, the control unit 14 outputs an operating prompt by way of the output unit 12. The action by the operator could be for example an operating input by means of the operating unit. Alternatively or additionally the action could be for example the treatment of a food to be cooked, in particular standing and/or lying it in position and/or turning it and/or adding food to be cooked and/or ingredients.

If in the check step 40 the control unit 14 determines that all the recipe steps of the selected recipe have been performed, in a concluding step 42 the control unit 14 terminates the performance of the selected recipe (see FIGS. 9 and 10). In the concluding step 42 the control unit 14 automatically deactivates activated heating elements after completion of the selected recipe. In the concluding step 42 the control unit 14 outputs information relating to completion of the selected recipe to the operator by way of the output unit 12. In the concluding step the control unit could output an operating prompt, in particular to confirm completion of the selected recipe, by way of the output unit.

In the method for operating the cooktop apparatus 10 a catalog of recipes for selection is output by the control unit 14 by way of the output unit 12. An operator is guided through a selected recipe as a function of an operating input.

The control unit 14 has a storage unit (not shown). A plurality of recipes are stored in the storage unit of the control unit 14. The recipes stored in the storage unit together form the catalog of recipes. The recipes stored in the storage unit are predefined. The control unit 14 stores further recipes in the storage unit as a function of an operating input by means of the operating unit 26. The control unit 14 makes changes to recipes already stored in the storage unit, in particular to predefined recipes and/or recipes stored as a function of an earlier operating input, as a function of an operating input by means of the operating unit 26. The control unit 14 stores the changes to the recipe undertaken due to the operating input by means of the operating unit in the storage unit. For example the control unit could add a further recipe, which could be formed by the amended recipe. Alternatively the control unit could replace the existing recipe with the amended recipe. The control unit 14 amends at least one recipe from the catalog of recipes as a function of an operating input by means of the operating unit 26.

### REFERENCE CHARACTERS

10 Cooktop apparatus
12 Output unit
14 Control unit
16 Food to be cooked
18 Cooktop
20 Cooktop plate
22 Cookware
24 Variable cooking surface region
26 Operating unit
28 Selection step
30 Preheating step
32 Food step
34 Cooking step
36 Interaction step
38 Confirmation step
40 Check step
42 Concluding step

1-13. (canceled)

14. A cooktop apparatus, comprising:
an output unit; and
a control unit configured to output a catalog of recipes for selection by the output unit and to guide an operator through a selected one of the catalog of recipes by the output unit as a function of an operating input.

15. The cooktop apparatus of claim 14, wherein a first setpoint temperature of a first recipe step of at least one of the recipes differs essentially from a second setpoint temperature of a second recipe step of the at least one of the recipes.

16. The cooktop apparatus of claim 14, wherein a temperature is automatically adjusted based on the selected one of the catalog of recipes by the control unit.

17. The cooktop apparatus of claim 14, wherein the control unit has a timer for starting a second recipe step after a predetermined time period has elapsed after a first recipe step.

18. The cooktop apparatus of claim 17, wherein the control unit outputs an item of time information relating to at least one recipe step by the output unit.

19. The cooktop apparatus of claim 17, wherein the control unit outputs a notification relating to a transition from the first recipe step to the second recipe step by the output unit.

20. The cooktop apparatus of claim 14, wherein the control unit outputs an operating prompt by the output unit.

21. The cooktop apparatus of claim 20, wherein the operating prompt comprises a prompt to lie and/or stand food in position.

22. The cooktop apparatus of claim 20, wherein the operating prompt comprises a prompt to turn food.

23. The cooktop apparatus of claim 14, wherein the control unit deactivates a heating element automatically after completion of the selected one of the catalog of recipes.

24. The cooktop apparatus of claim 14, wherein the control unit has a storage unit configured to store at least one further recipe of the catalog of recipes as a function of the operating input.

25. A cooktop, comprising a cooktop apparatus including an output unit and a control unit configured to output a catalog of recipes for selection by the output unit and to guide an operator through a selected recipe by the output unit as a function of an operating input.

26. The cooktop of claim 25, constructed as an induction cooktop.

27. The cooktop of claim 25, wherein a first setpoint temperature of a first recipe step of at least one of the recipes differs essentially from a second setpoint temperature of a second recipe step of the at least one of the recipes.

28. The cooktop of claim 25, wherein a temperature is automatically adjusted based on the selected one of the catalog of recipes by the control unit.

29. The cooktop of claim 25, wherein the control unit has a timer for starting a second recipe step after a predetermined time period has elapsed after a first recipe step.

30. The cooktop of claim 29, wherein the control unit outputs an item of time information relating to at least one recipe step by the output unit.

31. The cooktop of claim 29, wherein the control unit outputs a notification relating to a transition from the first recipe step to the second recipe step by the output unit.

32. The cooktop of claim 25, wherein the control unit outputs an operating prompt by the output unit.

33. The cooktop of claim 32, wherein the operating prompt comprises a prompt to lie and/or stand food in position.

34. The cooktop of claim 32, wherein the operating prompt comprises a prompt to turn food.

35. The cooktop of claim 25, wherein the control unit deactivates a heating element automatically after completion of the selected one of the catalog of recipes.

36. The cooktop of claim 25, wherein the control unit has a storage unit configured to store at least one further recipe of the catalog of recipes as a function of the operating input.

37. A method for operating a cooktop apparatus, said method comprising:
outputting a catalog of recipes for selection by an output unit; and
guiding an operator through a selected one of the catalog of recipes as a function of an operating input by the output unit.
